(19) United States
(12) Patent Application Publication
(10) Pub. No.: US 2009/0260909 A1
(43) Pub. Date: Oct. 22, 2009

(54) Assembling Method of Tractor and Tractor

(75) Inventors: Yozo Oka, Osaka (JP); Nobuaki Takahashi, Osaka (JP)

Correspondence Address: JORDAN AND HAMBURG LLP, 122 EAST 42ND STREET, SUITE 4000, NEW YORK, NY, 10168, US

(73) Assignee: Yanmar Co., Ltd., Osaka-shi (JP)

(21) Appl. No.: 11/991,948

(22) PCT Filed: Jan. 4, 2006
(86) PCT No.: PCT/JP2006/300011

§ 371 Date: Mar. 13, 2008

(30) Foreign Application Priority Data
Sep. 15, 2005 (JP) 2005-268838

(51) Int. Cl. B62D 65/02; B60K 37/00; B62D 25/10; B60K 15/00; B60K 5/00; B60R 16/04; B23P 21/00

(52) U.S. Cl. 180/291; 180/90; 180/69.2; 180/69.4; 180/68.5; 29/469

(57) ABSTRACT

The present invention aims at the shortening of a main line which constitutes an assembly line. To achieve such an object, in the present invention, an assembly line is constituted of a main line and sub lines, and a first unit which is constituted by connecting a clutch part and a transmission part, a second unit which constitutes a prime mover part, a third unit to which a support body and parts such as a handle, pedals, a dashboard, a fuel tank and the like which are supported on the support body are assembled, a fourth unit to which a front support body and parts such as a battery and a radiator which are supported on the front support body are assembled, a fifth unit to which steps, fenders and the like are assembled, and a sixth unit which is a hood are preliminarily assembled on sub lines and, thereafter, the above-mentioned first to sixth units are assembled together on the main line.

### BACKGROUND OF THE INVENTION

1. Field of the Invention

The present invention relates to a method for efficiently assembling a tractor and the structure of the tractor.

2. Description of the Related Art

Conventionally, as one mode of a method for assembling a tractor, there has been known a method in which the tractor is assembled on one-line assembly line based on the flow production (see patent document 1, for example).

That is, on one-line assembly line, first of all, a body frame is assembled and, subsequently, parts which are to be mounted on the body frame are sequentially assembled to the body frame based on the flow production thus completing the tractor.

However, the above-mentioned assembling method still has following drawbacks.

(1) Since the assembling operation is performed on one-line assembly line, the assembly line becomes elongated.

(2) Since it is necessary to arrange parts to be sequentially assembled along the assembly line, the assembly operation becomes cumbersome.

(3) When a trouble occurs even at one portion of the assembly line, it is necessary to stop the whole assembly line thus exhibiting the poor operability.

Further, as a mode of a tractor, there has been known a tractor which mounts a partition wall which partitions a prime mover part and a driving part on a traveling body, and a dashboard support member, a pedal support member and a steering column support member are respectively mounted on the partition wall (see patent document 2, for example).

However, in the above-mentioned tractor, since the dashboard support member, the pedal support member and the steering column support member are respectively mounted on the partition wall, from a viewpoint of the assembling order, there arises a drawback that the above-mentioned support member and support member cannot be mounted on the traveling body until the partition wall is mounted on the traveling body in an erected manner.

As a result, to consider the whole assembling operation of the tractor, the number of assembly man-hours is still large and the assembling operation is cumbersome.

Further, as one mode of the tractor, there has been known a tractor in which a support body having a gate shape as viewed in a back view is mounted on a traveling body in an erected manner at a position right behind the engine, and a hood is provided in front of the support body in a state that the hood is opened or closed, while a dashboard is mounted behind the support body (see patent document 3, for example).

Further, a fuel tank which is formed in a bent shape above and behind a rear portion of the engine is mounted on the support body, and the fuel tank is covered with the hood and the dashboard.

However, in the above-mentioned tractor, since the hood, the dashboard and the fuel tank are supported on the support body which is mounted on the traveling body in an erected manner, it is necessary to make parts which constitute the support body large-sized and to ensure the rigidity whereby the manufacturing cost can be pushed up accordingly.

Further, it is necessary to provide a hot air shielding body which shields hot air flowing into the dash board side from the hood side. Such a hot air shielding body gives rise to cumbersomeness that the hot air shielding body must be mounted at inner positions above the left and right sides of the support body while avoiding the interference with the fuel tank.

Further, the fuel tank is arranged in a bent manner above and behind the rear portion of the engine and hence, to perform the maintenance operation of the fuel tank, there arises cumbersomeness that both of the hood and the dashboard must be removed from the support body.

Further, as one mode of a tractor, there has been known a tractor which forms a laterally extending member extending in the lateral direction transversely between front ends of a pair of left and right longitudinally extending members which extend longitudinally, wherein a front support body of the tractor is mounted in a state that rear portions of the longitudinally extending members are arranged below left and right side walls of an engine in an overlapped state and, at the same time, the rear portion is fastened by fastening bolts from the outside (see patent document 4, for example).

However, a distance in the lateral direction between the above-mentioned pair of left and right longitudinally extending members is set slightly wider than a lateral width between lower portions of left and right side walls of the engine in view of the assembling operation and hence, there arises a drawback that even when the longitudinally extending members are strongly fastened by the fastening bolts, the favorable hermetic sealing between the longitudinally extending member and the lower positions of left and right side walls cannot be ensured.

That is, since the favorable hermetic sealing cannot be ensured between the longitudinally extending members and lower portions of the left and right side wall of the engine, no friction force is generated between the longitudinally extending members and the engine. Accordingly, all of a load of the engine is applied only to fastening bolts as a shearing force thus giving rise to a drawback that the fastening bolts may rupture.

Patent document 1: Japanese Patent Laid-open Hei6(1994)-16058
Patent document 2: Japanese Accepted Patent Hei7(1995)-57596
Patent document 3: Japanese Patent Laid-open 2003-237637
Patent document 4: Japanese Patent Laid-open 2003-48571

### SUMMARY OF THE INVENTION

(1) According to a first aspect of the present invention, an assembly line is constituted of a main line and sub lines, and a first unit which is constituted by connecting a clutch part and a transmission part, a second unit which is constituted by assembling parts such as a handle, pedals, a dashboard and a fuel tank to a prime mover part byway of a support member, a third unit which is constituted by assembling a front support body and parts such as a battery and a radiator which are supported on the front support body, a fourth unit which is constituted by assembling a step, a fender or the like, and a fifth unit which is constituted of a hood are preliminarily assembled on sub lines and, thereafter, the above-mentioned first to fifth units are assembled together on the main line.

In this manner, the assembly line is divided into the main line and the sub lines, the parts to be assembled are preliminarily assembled in parallel as the first to fifth units on the sub lines, and these first to fifth units are merged and assembled together on the mainline. Accordingly, it is possible to shorten the main line which constitutes the assembly line and, at the same time, it is unnecessary to arrange a large number of operators and a large kinds of assembling members along the main line and hence, it is possible to simplify the assembling operation on the main line.

Further, on the main line, it is sufficient to only assemble the first to fifth units which are preliminarily assembled on the sub lines and hence, the number of times that the main line is stopped due to troubles can be reduced compared to the conventional tractor assembling method and the operability of the whole assembling operation can be largely enhanced.

(2) In the second mode according to the present invention, a dashboard support member which supports the dashboard is arranged behind the engine, and a pedal support member and a steering column support member are mounted on the dashboard support member.

In this manner, since the pedal support member and the steering column support member are mounted on the dashboard support member which is provided to the engine, by integrally mounting the dashboard, the pedal and the steering shaft and, further, a steering wheel on the engine which constitutes a large-sized member by way of the support member and a support member, it is possible to form an engine unit which is a large-sized unit.

Accordingly, by preliminarily assembling the above-mentioned engine unit and by assembling the engine unit into other unit, it is possible to largely reduce the assembling man-hours on the assembly line of the tractor thus further enhancing the operability of the assembling operation.

(3) In a third mode according to the present invention, a hood support member which supports the hood is mounted on a dashboard support member.

In this manner, by mounting the hood support member on the dashboard support member which is provided to the engine, it is possible to easily mount the hood on the engine unit by way of the hood support member and hence, the operability of the tractor assembling operation can be further enhanced.

(4) In a fourth mode according to the present invention, a dashboard support member which supports a dashboard is provided behind an engine, and a hood support member which supports a hood and is formed in a gate shape as viewed in a back view is mounted on the dashboard support member, and the hood is supported on the hood support member in a state that the hood is opened or closed.

In this manner, by providing the dashboard support member which supports the dashboard behind the engine, by mounting the hood support member on the dashboard support member, and by allowing the hood support member to support the hood thereon in a state that the hood is opened or closed, it is possible to allow the respective support members to surely support the dashboard and the hood and, at the same time, it is possible to form the respective support members in a compact form.

(5) In a fifth mode according to the present invention, the hood support member is formed in a gate shape as viewed in a back view by transversely extending a lateral support member forming member which extends laterally between a pair of left and right longitudinal support member forming members which extends vertically longitudinally, the hood mounting body is mounted on the lateral support member forming member, and a hot air shielding body is extended over the pair of left and right longitudinal support member forming members in a state that hot air shielding bodies extend outwardly, and the hood side and the dashboard side are shielded with the hot air shielding body.

In this manner, it is possible to simply mount the hot air shielding body to the longitudinal support member forming member of the hood support member which supports the hood and, at the same time, it is possible to surely shield the hood side and the dashboard side by the hot air shielding body and hence, the inflow of hot air into the dashboard side from the hood side can be prevented. As a result, it is possible to ensure the favorable comfortableness of an operator who performs a driving operation while sitting in a driving portion.

(6) In a sixth mode according to the present invention, a fuel tank is formed in a longitudinally extending manner and, at the same time, in a state that the fuel tank is inserted into the hood support member having a gate shape as viewed in a back view, the fuel tank is supported at a position above the engine by way of a fuel tank support frame.

In this manner, since the fuel tank is formed in the longitudinally extending manner, a content capacity of the fuel tank can ensure as large quantity as possible.

Further, the fuel tank is supported at the position above the engine by way of the fuel tank support frame in a state that the fuel tank is inserted into the hood support member having a gate shape as viewed in a back view. Accordingly, in performing the maintenance operation of the fuel tank, by releasing the fixing of the fuel tank to the fuel tank support frame so as to allow the fuel tank to slide toward the front side of the body, it is possible to easily take out the fuel tank through the open space of the hood.

Accordingly, in performing the maintenance operation of the fuel tank, it is unnecessary to perform the operation to take out the hood and the dashboard and hence, the operability of the maintenance of the fuel tank can be enhanced.

(7) In a seventh embodiment according to the present invention, a front support body is arranged in front of the engine and, at the same time, the front support body is connected to lower portions of left and right side walls of the engine by way of a pair of left and right longitudinally extending connecting bodies.

In this manner, in connecting the front support body to the lower portions of left and right side walls of the engine by way of the pair of left and right longitudinally extending connecting bodies, by performing the connection by fastening the fastening bolts in a state that the rear portion of the connecting body is overlapped to the lower portions of the left and right side walls of the engine, it is possible to ensure the favorable sealing property between the connecting body and the lower portions of the left and right side walls of the engine.

As a result, the load of the engine is received by the connecting body by way of the fastening bolts and hence, the rupture of the fastening bolts can be prevented.

Further, the assembling operation to assemble the front support body to the engine becomes easy thus enhancing the operability of the assembling operation.

(8) In an eighth embodiment according to the present invention, a battery arranging recessed portion is formed in the front support body.

In this manner, since the battery arranging recessed portion is formed in the front support body, by merely arranging the battery in the battery arranging recessed portion, it is possible to easily perform both of the positioning of the battery and the stable fixing operation whereby the operability of the battery arranging operation can be enhanced.

Further, since the battery is arranged in the battery arranging recessed portion, it is possible to arrange the battery at a position as low as possible in front of the engine. As a result, the flow of cooling air which is taken into the inside of the hood from the front side is not interrupted by the battery and hence, the engine cooling effect can be enhanced.

(9) In a ninth mode according to the present invention, a front axle mounting seat is mounted on a front support body.

In this manner, by mounting the front axle mounting seat on the front support body, it is possible to easily and surely mount the front axle by way of the front axle mounting seat and hence, the operability of the front axle mounting operation can be enhanced.

(10) In a tenth embodiment according to the present invention, a front weight mounting portion which extends in the lateral direction is formed on the front end portion of the front support body and, at the same time, the front weight mounting portion is arranged at a frontmost portion of the body.

In this manner, by forming the front weight mounting portion which extends in the lateral direction on the front end portion of the front support body and, at the same time, by arranging the front weight mounting portion at the frontmost portion of the body, in a state that a front weight is removed from the front weight mounting portion (front-weight non-mounting state), the front weight mounting portion also functions as a bumper and hence, the occurrence of damages on the body such as hood can be prevented.

### BRIEF DESCRIPTION OF THE DRAWINGS

FIG. 1 is a side view of a tractor according to the present invention;

FIG. 2 is a plan view of the tractor;

FIG. 3 is a perspective explanatory view of first to fifth units of the tractor;

FIG. 4 is an explanatory side view of a front half portion of the tractor;

FIG. 5 is an explanatory plan view of the front half portion of the tractor;

FIG. 6 is a perspective view of a second unit;

FIG. 7 is a side view of the second unit;

FIG. 8 is a plan view of the second unit;

FIG. 9 is a back view of the second unit;

FIG. 10 is a plan view of a third unit;

FIG. 11 is a cross-sectional side view of the third unit;

FIG. 12 is a bottom plan view of the third unit;

FIG. 13 is an explanatory side view of a pivotally support body; and

FIG. 14 is an explanatory plan view of the pivotally support body.

### DESCRIPTION OF THE PREFERRED EMBODIMENT

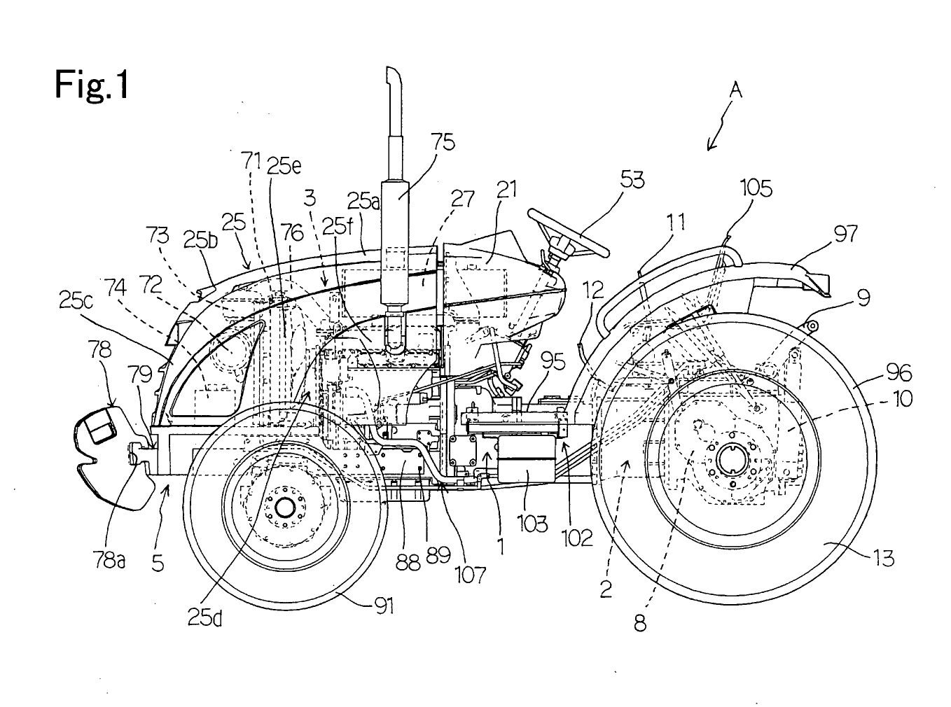

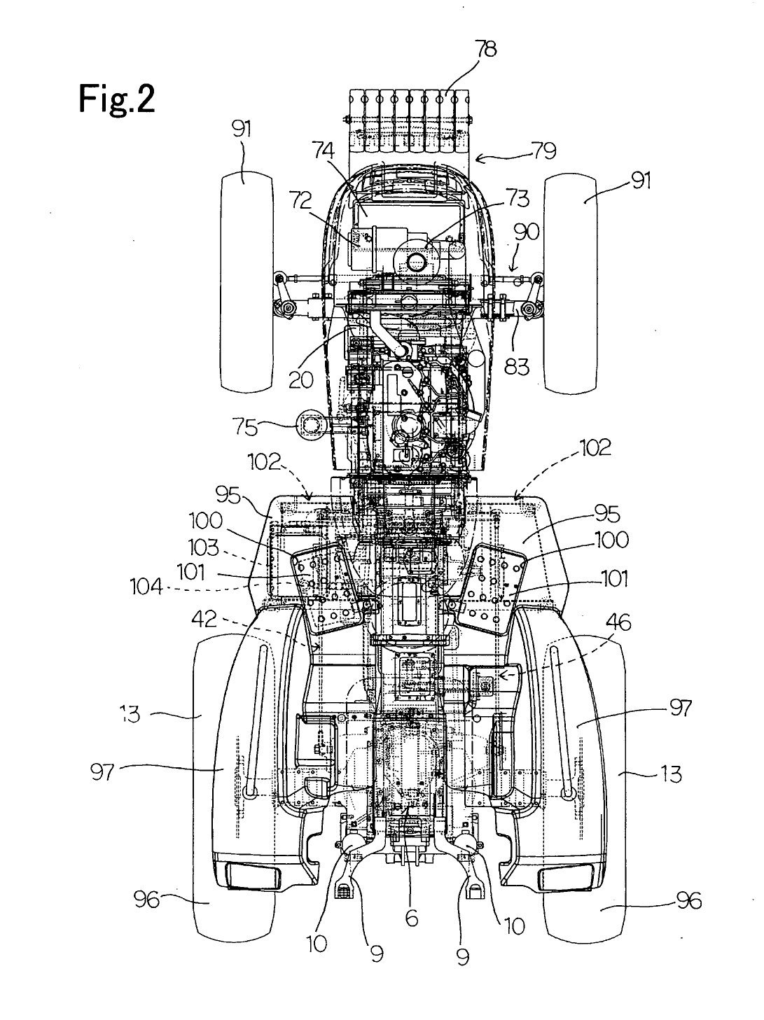

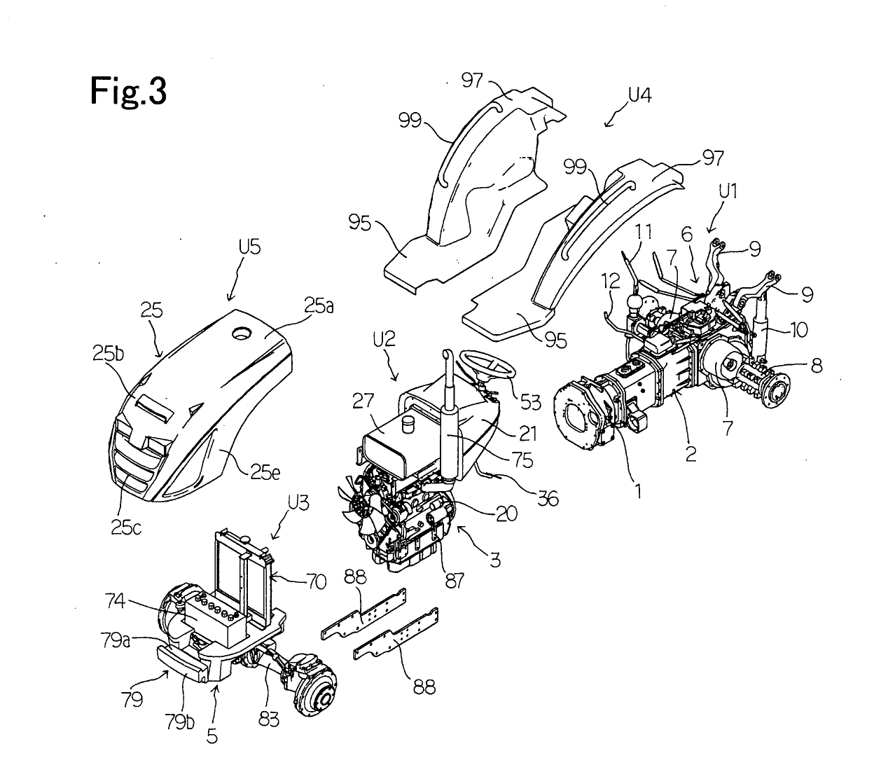

Symbol A shown in FIG. 1 and FIG. 2 indicates a tractor according to the present invention. The tractor A is, as also shown in FIG. 3, constituted by assembling a first unit U1 in which a clutch part 1 and a transmission part 2 are connected to each other, a second unit U2 in which parts such as a handle, pedals, a dashboard and a fuel tank are assembled to a prime mover part 3 by way of supporting members, a third unit U3 in which a front support body 5 and parts such as a battery and a radiator which are supported on the front support body 5 are assembled, a fourth unit U4 in which steps, fenders and the like are assembled together and a fifth unit U5 which constitutes a hood.

An assembly line is constituted of a main line and sub lines. The above-mentioned respective first to fifth units U1 to U5 are individually assembled preliminarily on the sub lines and, subsequently, these first to fifth units U1 to U5 are assembled together on the main line.

In this manner, the assembly line is divided into the main line and the sub lines and, the parts to be assembled are respectively assembled in parallel as the first to the fifth units U1 to U5 on the sub lines preliminarily and, thereafter, the first to the fifth units U1 to U5 are merged together and assembled on the main line and hence, it is possible to reduce a length of the main line which constitutes an assembly line and, at the same time, it is not necessary to arrange a large number of operators and a large number of kinds of parts to be assembled along the main line thus simplifying the assembling operation on the main line.

Further, since only the assembling of the first to the fifth units U1 to U5 which are preliminarily assembled on the sub lines is performed on the main line, it is possible to reduce the number of stopping times of the main line attributed to troubles compared to the conventional method and hence, it is possible to largely enhance the operability of the whole assembling operation.

Hereinafter, the explanation is made for every unit in conjunction with drawings.

### [Explanation of the First Unit U1]

In the first unit U1, as shown in FIG. 1 to FIG. 3, a front end peripheral portion of a transmission part 2 is interlockingly connected with a rear end peripheral portion of a clutch part 1, an elevating operation portion 6 is mounted on an upper portion of the transmission part 2, and left and right brake parts 7, 7 and left and right rear axle housings 8, 8 are mounted on the rear portions of left and right side walls of the transmission part 2. Numeral 9 indicates a lift arm, numeral 10 indicates a lift cylinder, numeral 11 indicates a main transmission lever, numeral 12 indicates a sub transmission lever and numeral 13 indicates a rear wheel.

### [Explanation of the Second Unit U2]

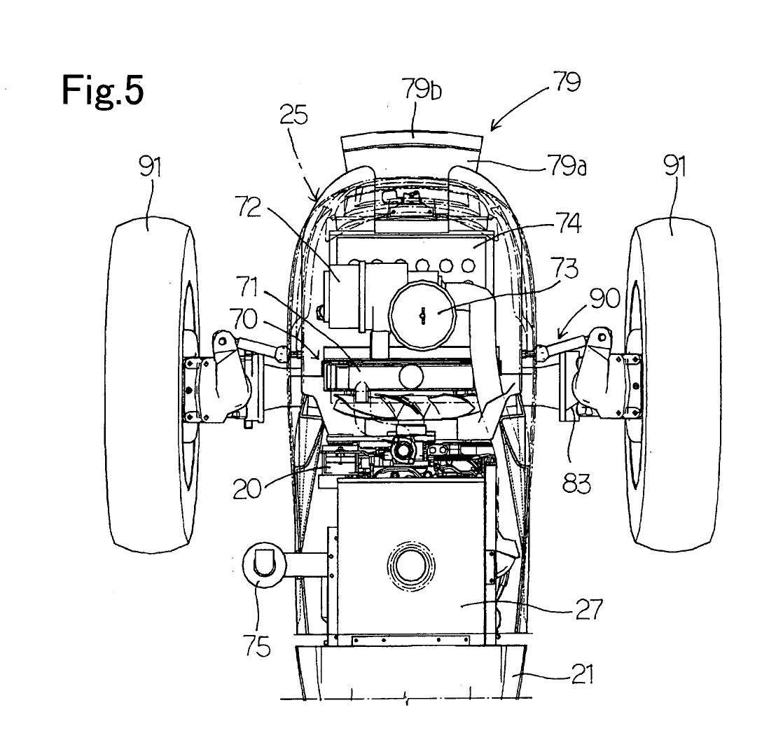

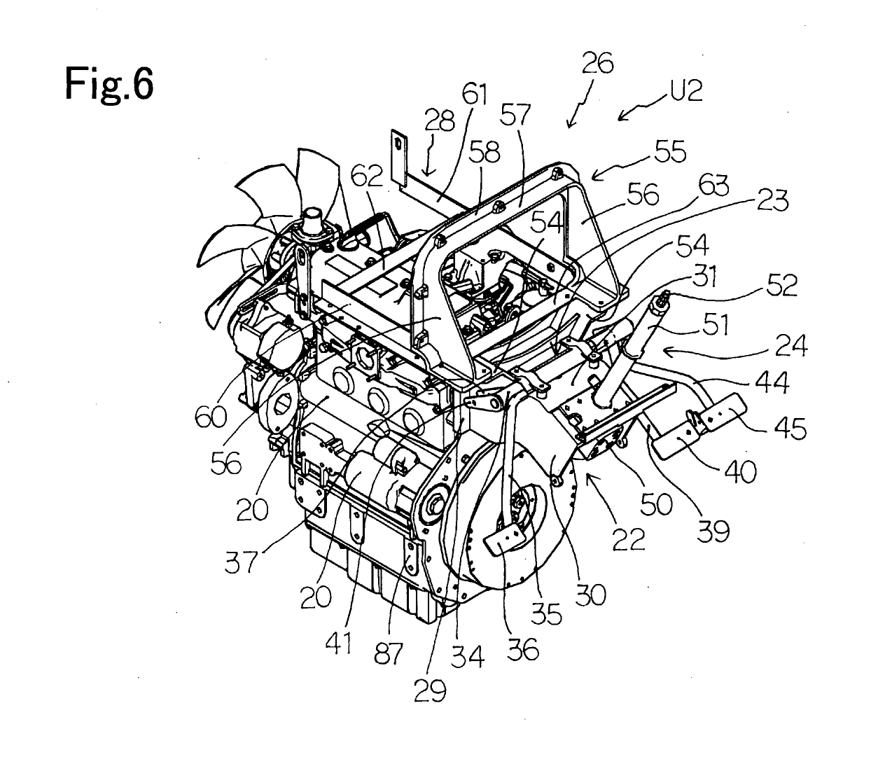

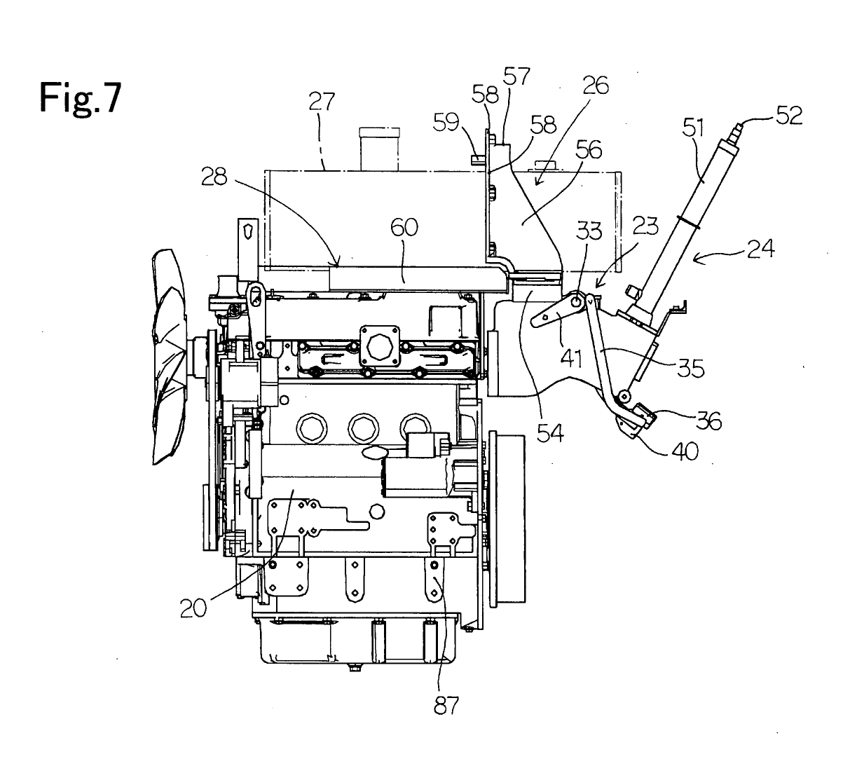

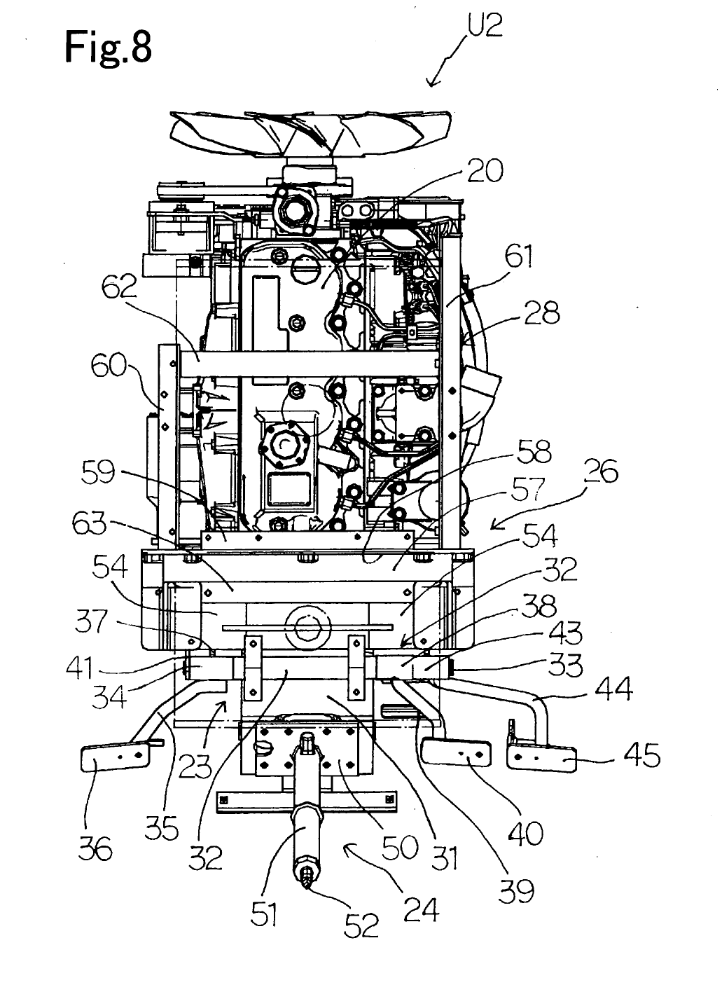

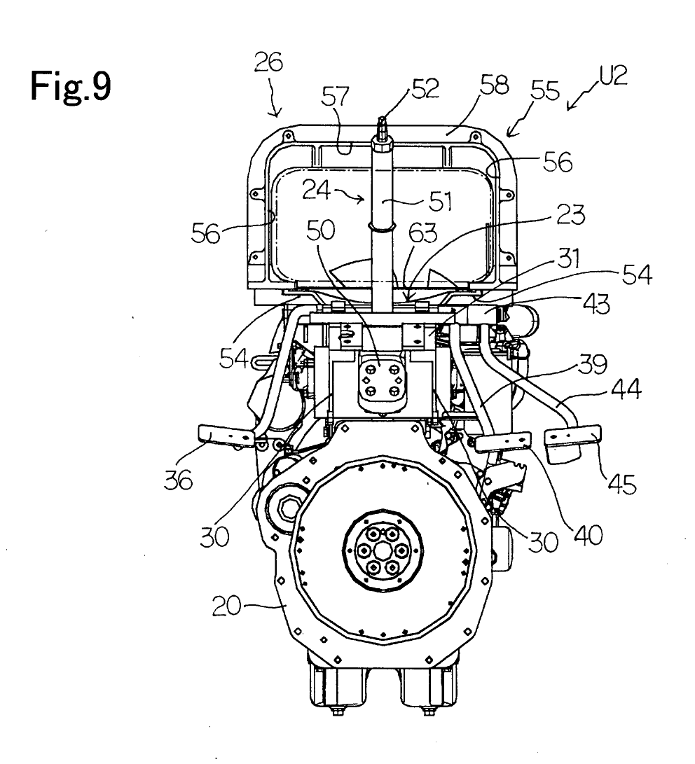

The second unit U2, as shown in FIG. 1 to FIG. 9, is configured such that parts such as a handle, pedals, a dashboard and a fuel tank are connected to a prime mover part 3 by way of respective support portions. In the prime mover part 3, as shown in FIG. 6 to FIG. 9, a dashboard support member 22 which supports a dashboard 21 is formed on a rear wall of an engine 20, a pedal support member 23 and a steering column support member 24 are mounted on the dashboard support member 22 and, at the same time, a hood support member 26 which supports a hood 25 is formed on the dashboard support member 22 by way of a support member body 55 described later.

Then, at a position right above the engine 20, a fuel tank support frame 28 which supports a fuel tank 27 is arranged.

The dashboard support member 22 is, as shown in FIG. 6 to FIG. 9, configured such that a front surface of a plate-like mounting body 29 which extends in the lateral direction is mounted on an upper portion of a rear wall of the engine 20 in a state that the front surface faces the upper portion of the rear wall of the engine in an opposed manner, front end surfaces of a pair of left and right support members 30, 30 which extend in the longitudinal direction are fixedly mounted on a rear surface of the mounting body 29, a support plate member 31 is provided in an extended manner between the front portions of the upper end surfaces of both support members 30, 30 and a dashboard 21 is supported on the dashboard support member 22.

The pedal support member 23 is formed such that a cylindrical shaft supporting body 32 which extends in the lateral direction is fixed to a support plate member 31 of the above-mentioned dashboard support member 22 and the pedal support shaft 33 which extends in the lateral direction is inserted in the shaft supporting body 32.

Then, a clutch pedal boss portion 34 is rotatably fitted on a left-side end portion of the pedal support shaft 33 which projects leftwardly from the shaft supporting body 32, a clutch pedal 36 is mounted on the clutch pedal boss portion 34 by way of a clutch pedal arm 35 which extends in the vertical direction and a clutch pedal boss portion 34 is interlockingly connected with a clutch mechanism (not shown in the drawing) which is assembled in the clutch part 1 by way of a clutch operation arm 37.

Further, a left brake pedal boss portion 38 is fitted on the right-side end portion of the pedal support shaft 33 which projects rightwardly from the shaft supporting body 32 and a left brake pedal 40 is mounted on the left brake pedal boss portion 38 by way of a left brake pedal arm 39 which extends in the vertical direction. The left brake pedal boss portion 38 is interlockingly connected with the pedal supporting shaft 33 and a left brake operation arm 41 is mounted on the left-side end portion of the pedal support shaft 33 and the left brake portion 7 is interlockingly connected with the left brake arm 41 by way of a left brake interlocking mechanism 42 (see FIG. 2).

On the other hand, a right brake pedal boss portion 43 is rotatably fitted on the right-side end portion of the pedal support shaft 33 which projects rightwardly from the shaft supporting body 32 and a right brake pedal 45 is mounted on the right brake pedal boss portion 43 by way of a right brake pedal arm 44 which extends in the vertical direction. A right brake operation arm (not shown in the drawing) is mounted on the right brake boss portion 43 and the right brake portion 7 is interlockingly connected with the right brake operation arm by way of a right brake interlocking mechanism 46 (see FIG. 2).

The steering column support member 24 is configured such that a power steering valve 50 is mounted between the rear portions of the support members 30, 30 of the dashboard support member 22 and a lower end portion of a steering column 51 which extends in the vertical direction is mounted on a ceiling portion of the power steering valve portion 50. A steering shaft 52 is inserted in the steering column 51 and a lower end portion of the steering shaft 52 is interlockingly connected with the power steering valve portion 50, while a steering wheel 53 is mounted on an upper end portion of the steering shaft 52.

In a hood support member 26, a pair of left and right projecting support bodies 54, 54 is formed on front portions of left and right sides of the support plate member 31 of the above-mentioned dashboard support member 22 in a state that the left and right projecting support bodies 54, 54 project outwardly and a support member body 55 which is formed in a gate shape as viewed in a back view strides between upper surface portions of both of the projecting support bodies 54, 54.

Then, the support member body 55 is formed in a gate shape as viewed in a back view by extending a lateral support member forming member 57 which extends in the left-and-right lateral direction between a pair of left and right longitudinal support member forming members 56, 56 which extend in the vertical longitudinal direction and a hot air shielding body 58 having a gate shape viewed in a back view is mounted in an outwardly projecting manner along a front end peripheral portions of these longitudinal support member forming members 56, 56 and the lateral support body member forming member 57 so as to prevent the hot air on the hood 25 side from flowing in from the dashboard 21 side using the hot air shielding body 58.

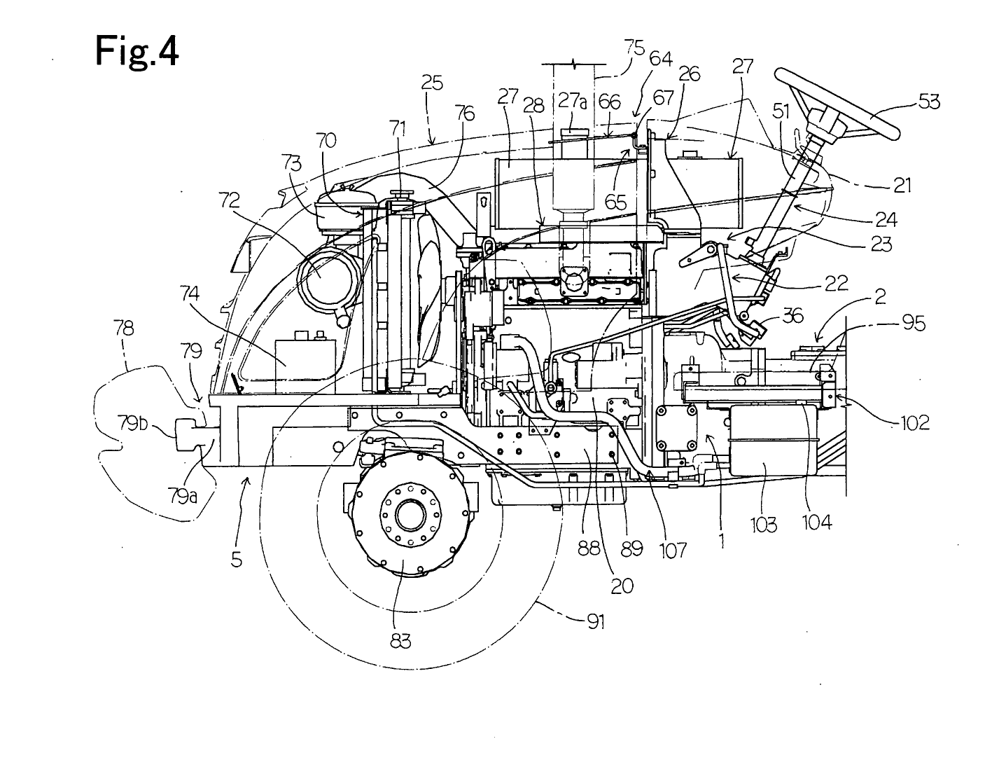

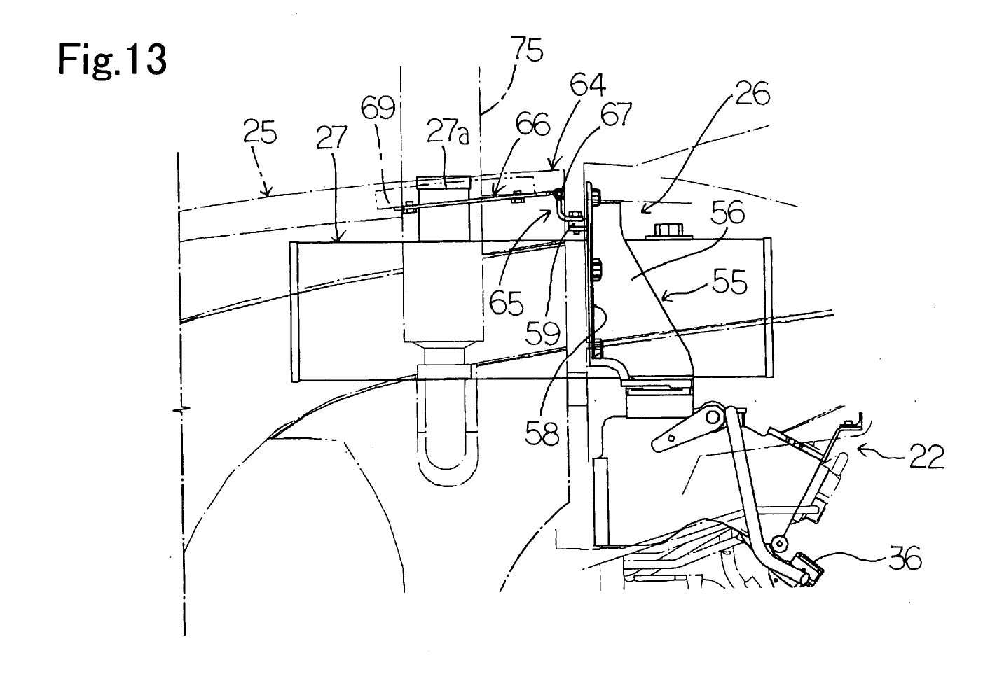

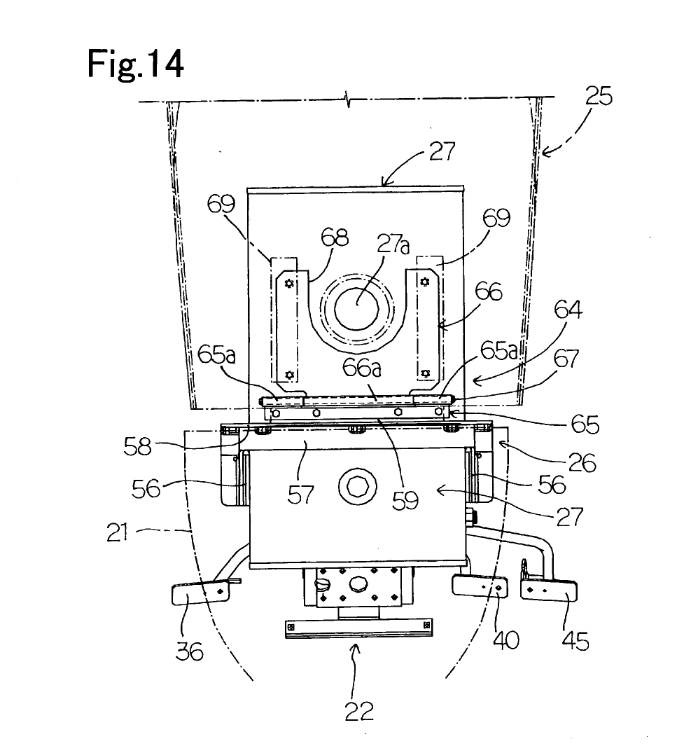

Further, on the upper portion of the hot air shielding body 58, a plate-like hood mounting body 59 which extends in the lateral direction is mounted in a frontwardly projecting manner and the hood 25 is mounted on the hood mounting body 59 in a state that the hood 25 can be opened or closed by way of a pivotally support body 64 described later (see FIG. 4, FIG. 13 and FIG. 14).

Here, the fuel tank 27 which extends in the longitudinal direction and is formed in a quadrangular box shape is formed in a state that the fuel tank 27 can be inserted in the support member body 55 in the longitudinal direction.

The fuel tank support frame 28 is formed into a frame constituted of a pair of left and right longitudinally extending members 60, 61 which extend in the longitudinal direction and a pair of laterally extending members 62, 63 which extend in the lateral direction on front and rear sides and is arranged at a position right above the engine 20.

That is, in the fuel tank support frame 28, the left-side longitudinally extending member 60 is supported on an exhaust manifold 20a which is mounted on the left upper portion of the engine 20 by way of a left support bracket (not shown in the drawing), while the right longitudinally extending member 61 is supported on an intake manifold 20b which is mounted on the right upper portion of the engine 20 by way of a right support bracket (not shown in the drawing) and, further, the laterally extending member 63 on a rear side is mounted across between a pair of left and right projecting support bodies 54, 54 and is arranged right above the engine 20.

Then, the fuel tank 27 is mounted on the above-mentioned fuel tank support frame 28 and the fuel tank 27 is supported and fixed by fastening using a fastening member such as a belt. The fuel tank 27 is supported and fixed on the fuel tank support frame 28 in a state that, as described above, the fuel tank 27 is inserted in the support member body 55.

The second unit U2 is constituted as described hereinabove. In the second unit U2, since the pedal support member 23 and the steering column support member 24 are mounted on the dashboard support member 22 which is formed on the engine 20, the dashboard 21, the clutch pedal 36 and the left and right brake pedals 40, 45, the steering shaft 52 and, further, the steering wheel 53 are integrally mounted on the engine 20 which constitutes a large-sized member by way of these support member 22 and support members 23, 24 thus forming all these parts including the engine 20 into a large-sized unit which may be referred to as an engine unit.

Accordingly, by preliminarily assembling the above-mentioned engine unit and by assembling the engine unit with other units, it is possible to reduce the assembling steps on the assembly line of the tractor A compared to the conventional assembling method thus further enhancing the assembling operability.

Further, since it is possible to mount the fuel tank 27 to the large-sized member which constitutes the engine 20 by way of the fuel tank support frame 28, it is possible to realize a further large-sized unit which constitutes the engine unit provided with the fuel tank 27.

Further, since the hood support member 26 is formed on the dashboard support member 22, it is possible to easily mount the hood 25 on the engine unit provided with the fuel tank 27 by way of the hood support member 26 thus further enhancing the assembling operability of the tractor A.

Then, the dashboard support member 22 which supports the dashboard 21 is formed behind the engine 20 and the hood support member 26 is formed on the dashboard support member 22 and, at the same time, the fuel tank support frame 28 which supports the fuel tank 27 is arranged at a position right above the engine 20 and hence, it is possible to surely support these dashboard 21, the hood 25 and the fuel tank 27 using the respective support members 22, 26 and the fuel tank support frame 28 and, at the same time, it is possible to form the respective support members 22, 26 and the fuel tank support frame 28 in a compact structure.

Here, it is possible to easily mount the hot air shielding body 58 to the support member body 55 of the hood support member 26 which supports the hood 25 and, at the same time, it is possible to surely shield the hood 25 side and the dashboard 21 side using the hot air shielding body 58 and hence, it is possible to prevent the hot air from flowing into the dashboard 21 side from the hood 25 side.

As a result, it is possible to favorably assure the comfortableness of an operator who takes the driver's seat and performs the driving operation.

Further, since the fuel tank 27 is formed in an extending manner in the longitudinal direction, it is possible to assure the capacity of the fuel tank 27 as large as possible.

Still further, since the fuel tank is inserted in the support member body 55 in a gate shape as viewed in a back view and is supported on the fuel tank support frame 28, when the maintenance operation of the fuel tank 27 is performed, by upwardly rotating the fuel tank 27 using the rear end portion thereof as a fulcrum and, at the same time, by releasing the fixing of the fuel tank 27 to the fuel tank support frame 28, the fuel tank 27 is allowed to slide frontwardly in the body and to be easily taken out through the opening space of the hood 25.

Accordingly, since the removing operation of the hood 25 and the dashboard 21 is not necessary, it is possible to enhance the maintenance operability of the fuel tank 27.

### [Explanation of the Third Unit U3]

In the third unit U3, as shown in FIG. 1 to FIG. 5, a radiator 71 is arranged on the front support body 5 by way of a support frame body 70, an air cleaner 72 is arranged at a position right in front of the radiator 71 by way of the above-mentioned support frame body 70, a pre-cleaner 73 is arranged at a position right above the air cleaner 72, while a battery 74 is arranged at a position right below the above-mentioned air cleaner 72. Numeral 75 indicates a muffler and numeral 76 indicates an intake pipe.

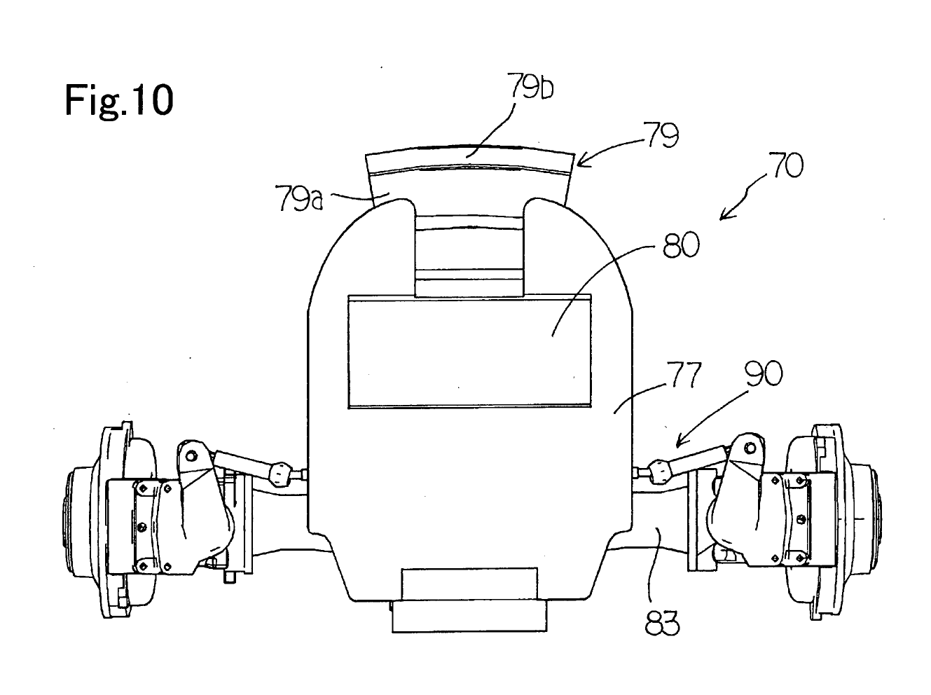

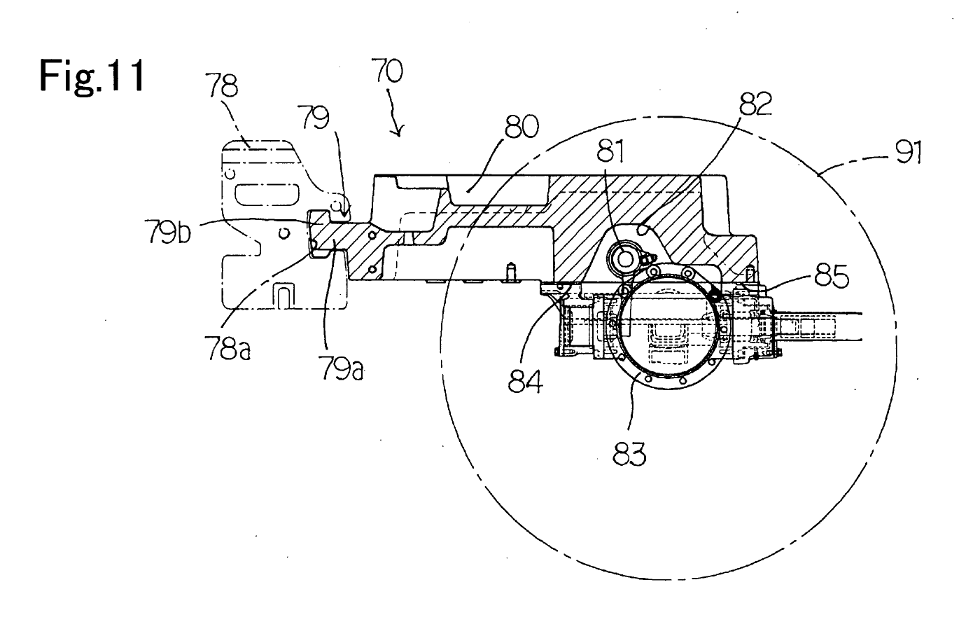

Then, the front support body 5 is, as shown in FIG. 10 to FIG. 12, formed of a support body frame 77 which is formed in a thick plate-like shape by casting, a front weight mounting portion 79 which is integrally formed with a front end peripheral portion of the support body frame 77, extends in the lateral direction and is capable of detachably mounting the front weight 78 thereon, a battery arranging recessed portion 80 which is integrally formed in a quadrangular stepped recessed shape extending in the lateral direction on the upper surface front portion of the support body frame 77 and is capable of arranging the battery 74 thereon in a fitting state, a cylinder mounting recessed portion 82 which is integrally formed in an upwardly recessed state extending in the lateral direction on the lower surface rear portion of the support body frame 77 and is capable of mounting a power steering cylinder 81 thereon and front axle mounting seats 84, 85 which are integrally formed in front of and behind the cylinder mounting recessed portion 82 and is capable of mounting the front axle 83 thereon.

Here, the front weight mounting portion 79 is configured as follows. As also shown in FIG. 1 to FIG. 5, the lower portion of the front end peripheral portion of the support body frame 77 is extended frontwardly so as to form a mounting base portion member 79a having a given lateral width and an engagement member 79b which projects upwardly and downwardly from the front end peripheral portion of the mounting base member 79a. The engagement member 79b is positioned in front of the hood 25 and is arranged on the foremost portion of the machine body.

Then, by engaging an engagement recessed portion 78a which is formed in the front weight 78 with the engagement member 79b from the left and right sides, it is possible to detachably mount the front weight 78 on the front weight mounting portion 79.

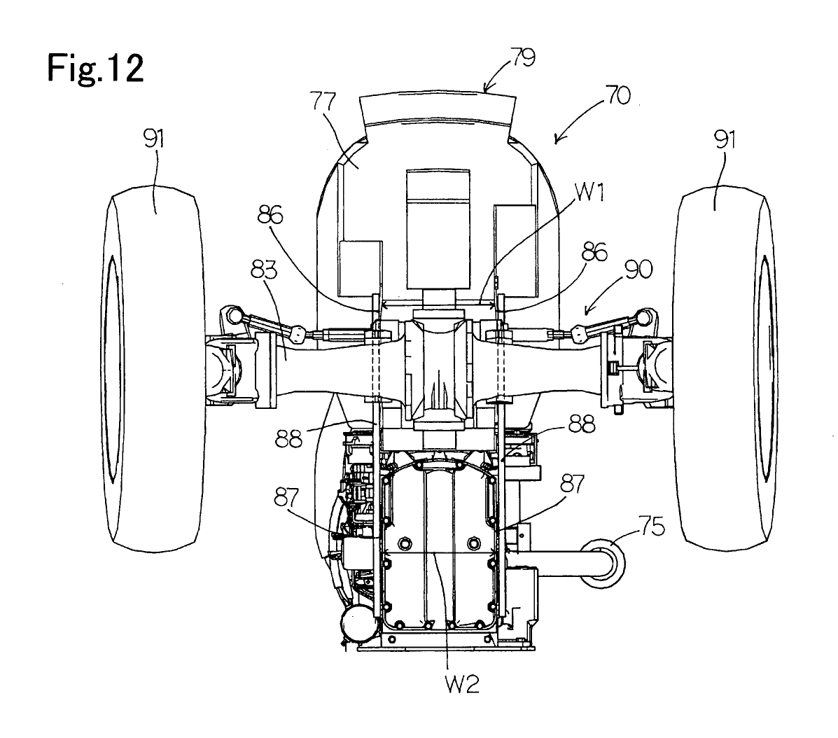

Further, on the left and right side walls of the front axle mounting seats 84, 85, as shown in FIG. 12, left and right front portion connection seats 86, 86 are formed, lateral width W1 between the left and right front portion connection seats 86, 86 is formed with an approximately equal width as the lateral width W2 between the left and right rear portion connection seats 87, 87 which is formed on the lower portion of the left and right side walls of the engine 20 and, the left and right front portion connection seats 86, 86 of the front support body 5 are connected to the left and right rear portion connection seats 87, 87 of the engine 20 by way of a pair of left and right connecting bodies 88, 88 which extends in the longitudinal direction in a straight strip shape. In FIG. 1 and FIG. 4, numeral 89 indicates a fastening bolt. In FIG. 12, numeral 90 indicates a power steering mechanism and numeral 91 indicates a front wheel.

In this manner, the battery arranging recessed portion 80 is mounted on the front support body 5 and hence, by only arranging the battery 74 in the inside of the battery arranging recessed portion 80, it is possible to easily perform the positioning of the battery 74 and the stable fixing operation thus enhancing the mounting operability of the battery 74.

Further, since the battery 74 is arranged in the inside of the battery arranging recessed portion 80, it is possible to set the position of the battery 74 as low as possible in front of the engine 20. As a result, compared to a case in which the battery 74 is mounted on the upper surface of the front support body 5, with respect to the cooling air which is taken into the hood 25 from a front side, the possibility that the flow of the cooling air is inhibited by the battery 74 is reduced and hence, it is possible to enhance the cooling effect of the engine 20.

Further, since the front axle mounting seats 84, 85 are formed on the front support body 5, the front axle 83 is easily and surely mounted on the front support body 5 by way of the front axle mounting seats 84, 85 and hence, it is possible to enhance the mounting operability of the front axle 83.

Then, the front weight mounting portion 79 which extends in the lateral direction is mounted on the front end portion of the front support body 5 and, at the same time, the front weight mounting portion 79 is arranged on the foremost portion of the machine body and hence, in a state that the front weight 78 is removed from the front weight mounting portion 79 (front weight non-mounted state), the front weight mounting portion 79 also functions as a bumper thus preventing the damages on the parts of the machine body such as a hood 25.

Further, when the front support body 5 is connected to the lower portions of the left and right side walls of the engine 20 by way of a pair of left and right connecting bodies 88, 88 which extend in the longitudinal direction, since the lateral width W1 between the left and right front portion connection seats 86, 86 which are formed on the left and right side walls of the front axle mounting seats 84, 85 and the lateral width W2 between the left and right rear portion connection seats 87, 87 which are formed on the lower portions of the left and right side walls of the engine 20 are formed with an approximately equal width, by connecting the rear portions of the connecting bodies 88, 88 with the left and right rear portion connection seats 87, 87 of the engine 20 in an overlapping state by fastening using fastening bolts 89, it is possible to favorably assure the contact property between the connecting bodies 88, 88 and the lower portions of the left and right side walls of the engine 20.

As a result, since the load of the engine 20 can be received by the connecting bodies 88, 88 by way of the fastening bolts 89, it is possible to reduce the shearing force which acts on the fastening bolts 89 and hence, it is possible to prevent the fastening bolts 89 from being broken.

Further, the assembling operation in which the front support body 5 is assembled to the engine 20 is facilitated and hence, it is possible to enhance the mounting operability.

### [Explanation of the Fourth Unit U4]

The fourth unit U4 is, as shown in FIG. 1 to FIG. 3, configured such that, at left and right positions of the front portion of the transmission part 2, left and right step fender bodies 98, 98 are integrally formed of the left and right step members 95, 95 which are arranged in an outwardly projecting manner and the left and right fender members 97, 97 which are arranged in a state that the left and right fender members 97, 97 cover the front and the above left and right rear wheels 96, 96 and grip members 99, 99 are mounted on the left and right fender members 97, 97.

Then, on the left and right step members 95, 95, as shown in FIG. 2, left and right maintenance opening portions 100, 100 are respectively mounted and the respective left and right maintenance opening portions 100, 100 are closed in a state that the respective left and right maintenance opening portions 100, 100 can be opened or closed using open/close lid bodies 101, 101.

Further, the left and right step members 95, 95 are, as shown in FIG. 1 and FIG. 2, mounted on the left and right step member support frame bodies 102, 102 which are formed in an outwardly projecting manner from the front portions of the left and right side walls of the transmission part 2 and supported on the left and right step member support frame bodies 102, 102.

Here, in this embodiment, a working oil tank 103 is arranged below the left step member 95 and is mounted on the left step member support frame body 102 and, at the same time, through the left maintenance opening portion 100 on which the open/close lid body 101 is mounted in an open state, oil is filled in an oil filling port portion 104 which is formed on the upper portion of the working oil tank 103 from the above the left step member 95.

Further, the left and right fender members 97, 97 are mounted and supported on the rear portion of the transmission part 2.

At a position above the rear portion of the transmission part 2 and between the left and right fender members 97, 97, a driver's seat 105 is arranged. The driving portion 106 is constituted of the driver's seat 105, the above-mentioned steering wheel 53, various pedals 36, 40, 45, various manipulation levers 11, 12 which are formed on the rear portion of the transmission part 2 and the like.

### [Explanation of the Fifth Unit U5]

The fifth unit U5 is, as shown in FIG. 1 to FIG. 3, constituted of the hood 25. The hood 25 is, as described above, mounted on the hood support member 26 and covers above the prime mover part 3 and the front support body 5 in a state that the hood 25 can be opened or closed.

Here, the hood 25 is, as shown in FIG. 1, formed of a ceiling portion 25a which is formed by being curved in a slightly slanted manner frontwardly and downwardly, a front upper portion 25b which is formed by being bent in a quarter circular shape from the front end peripheral portion of the ceiling potion 25a, a front wall portion 25c which is formed in a downwardly extending manner from the lower end peripheral portion of the front upper portion 25b, and left and right side wall portions 25d, 25d which are contiguously connected with the left and right peripheral portions of the front wall portion 25c and the left and right peripheral portions of the ceiling portion 25a in a smoothly curved shape.

Then, the left and right side wall portions 25d, 25d are, as shown in FIG. 1, formed of front half portion side wall forming bodies 25e, 25e and rear half portion side wall forming bodies 25f, 25f. The front half portion side wall forming bodies 25e, 25e are, after integrally forming the front half portion of the respective side wall portions 25d, 25d and the rear half upper peripheral portion of the respective side wall portions 25d, 25d, integrally formed in a state that the front half portion side wall forming bodies 25e, 25e are connected with the respective side peripheral portions of the ceiling portion 25a, the front upper portion 25b and the front wall portion 25c, while the rear half portion side wall forming bodies 25f, 25f are detachably mounted on the front support body 5 and the engine 20 and are formed in an erected manner.

Further, the above-mentioned pivotally support body 64 which pivotally supports the above-mentioned hood 25 on the hood mounting body 59 in a state that the hood 25 can be opened or closed is, as shown in FIG. 13 and FIG. 14, configured such that the mounting-body-side pivot support member 65 is mounted on the hood mounting body 59 and the mounting-body-side boss portion 65a with an axis thereof directed in the lateral direction is mounted on the mounting body pivot support member 65, while a hood-side pivot support member 66 is mounted on the rear portion of the inner surface of the ceiling portion 25a of the hood 25 and the hood-side boss portion 66a with an axis thereof directed in the lateral direction is mounted on the hood-side pivot support member 66, and a pivot shaft 67 which extends in the lateral direction is inserted in both of the boss portions 65a, 66a in a state that both of the boss portions 65a, 66a are coaxially coincided with each other. Numeral 27a indicates an oil filling port portion of the fuel tank 27, numeral 68 indicates a interference prevention notched portion which is formed for preventing the interference with the oil filling port portion 27a and numeral 69 indicates a mounting bracket.

As has been described hereinabove, in this embodiment, in the tractor A, the first to fifth units U1 to U5 are individually assembled on the sub line preliminarily and these first to fifth units U1 to U5 are assembled on the main line and, further, the driver's seat 105 shown in FIG. 1, the working oil pipe 107 and the like are added.

The assembling method of a tractor according to the present invention is useful for the structure of a tractor which is provided with a prime mover part, a clutch part, a transmission part, parts such as a handle, pedals, a dashboard, a fuel tank, parts such as front support body and a battery, a radiator and the like which are supported on the front support body, steps, fenders and the like and a hood.

1. A tractor assembling method, comprising
assembling first, second, third, fourth and fifth units on sub assembly lines,
said first unit being assembled by connecting a clutch part and a transmission part, said second unit being assembled by assembling parts comprising a handle, pedals, a dashboard and a fuel tank to a prime mover part by way of a support member, said third unit being assembled by assembling a front support body and parts comprising a battery and a radiator which are supported on the front support body, said fourth unit being assembled by assembling parts comprising a step and a fender, and a fifth unit being assembled by assembling parts comprising a hood, and
thereafter, assembling together said first to fifth units on a main assembly line.

2. A tractor comprising an engine, a dashboard support member supporting the dashboard and being arranged behind the engine, and a pedal support member and a steering column support member mounted on the dashboard support member.

3. A tractor according to claim 2, further comprising a hood support member mounted on the dashboard support member, and a hood supported by the hood support member.

4. A tractor, comprising an engine, a dashboard support member supporting the dashboard and being arranged behind the engine, a hood, a hood support member supporting the hood, when the hood is open or closed, the hood support member being formed in a gate shape as viewed in a back view and the hood support member being mounted on the dashboard support member.

5. A tractor according to claim 4, wherein the hood support member comprises a member forming a laterally extending lateral support and a pair of left and right members forming longitudinal supports which extend vertically longitudinally, the lateral support member extending transversely between said left and right members to form said gate shape, and the tractor further comprises a hood mounting body mounted on the lateral support member and a hot air shielding body extending over said left and right members and extending outwardly so as to be positioned between the hood and the dashboard.

6. A tractor according to claim 4, further comprising a longitudinally extending fuel tank inserted into the hood support member, and a fuel tank support frame, the fuel tank being supported at a position above the engine by the fuel tank support frame.

7. A tractor comprising an engine having left and right side walls, a front support body arranged in front of the engine and a pair of left and right longitudinally extending connecting bodies connecting the front support body to lower portions of left and right side walls of the engine.

8. A tractor according to claim 7, further comprising a recessed portion formed in the front support body for accommodating a battery.

9. A tractor according to claim 7, further comprising a front axle mounting seat mounted on the front support body.

10. A tractor according to claim 7, further comprising a laterally extending front weight mounting portion arranged at a frontmost portion of the front support body.
